(19) United States
(12) Patent Application Publication
(10) Pub. No.: US 2022/0254267 A1
(43) Pub. Date: Aug. 11, 2022

(54) INFORMATION PROCESSING APPARATUS AND CONTROL METHOD OF INFORMATION PROCESSING APPARATUS

(71) Applicant: Seiko Epson Corporation, Tokyo (JP)

(72) Inventor: Motoaki HARA, Suwa-shi (JP)

(21) Appl. No.: 17/649,833

(22) Filed: Feb. 3, 2022

(30) Foreign Application Priority Data
Feb. 5, 2021 (JP) 2021-017174

(51) Int. Cl. G09B 7/02; G06F 16/332; H04N 1/32; G09B 5/02

(52) U.S. Cl. CPC G09B 7/02; G09B 5/02; H04N 1/32128; G06F 16/3329

(57) ABSTRACT

An information processing server includes a server storage section that stores a question management record in which property information indicating a property of a question is associated with question data indicating a question, a first reception section configured to receive answered question paper read data from a complex machine, a first identification section configured to identify a property of a question included in the answered question paper based on the answered question paper read data received by the first reception section, and a selection section configured to select a question to be given to a learner from the question indicated by the question data stored in the server storage section based on the property identified by the first identification section.

The present application is based on, and claims priority from JP Application Serial Number 2021-017174, filed Feb. 5, 2021, the disclosure of which is hereby incorporated by reference herein in its entirety.

### BACKGROUND

### 1. Technical Field

The present disclosure relates to an information processing apparatus and a control method of an information processing apparatus.

### 2. Related Art

In selecting a question to be given to a learner, techniques are known for selecting the question in consideration of questions answered by the learner in the past. For example, JP-A-2014-157302 discloses a system for giving a related question regarding the teaching materials to a learner based on learned questions in teaching materials. In the system, based on the contents of a response made by a learner, the other related questions are extracted from the teaching materials.

In JP-A-2014-157302, it is assumed that a question regarding teaching materials to be answered by a learner is digital content, and no consideration is given to question paper made of a paper medium concerning selection of a question. Accordingly, with JP-A-2014-157302, it is not possible to select a question to be given to a learner in consideration of questions in the question paper, which were answered by the learner in the past.

### SUMMARY

According to an aspect of the present disclosure, there is provided an information processing apparatus including: a storage section storing association information associating property information indicating a property of a question and question data indicating a question; a first reception section configured to receive read data of answered question paper answered by a learner from a reading apparatus; a first identification section configured to identify a property of a question included in the answered question paper based on the read data received by the first reception section; and a selection section configured to select a question to be given to the learner from the question indicated by the question data stored in the storage section based on the property identified by the first identification section.

According to another aspect of the present disclosure, there is provided a control method of an information processing apparatus, the control method including: storing association information associating property information indicating a property of a question and question data indicating a question; receiving read data of answered question paper answered by a learner from a reading apparatus; identifying a property of a question of the answered question paper based on the received read data; and selecting a question to be given to the learner from the question indicated by the stored question data based on the identified property.

### BRIEF DESCRIPTION OF THE DRAWINGS

FIG. 1 is the configuration of an information processing system.

FIGS. 2A and 2B are diagrams illustrating the configuration of each apparatus in the information processing system.

FIG. 3 is a diagram illustrating an example of each database stored in a server storage section.

FIG. 4 is a flowchart illustrating the operation of the information processing system.

FIG. 5 is a diagram illustrating an example of teaching material read data.

FIG. 6 is a flowchart illustrating the operation of the information processing system.

### DESCRIPTION OF EXEMPLARY EMBODIMENTS

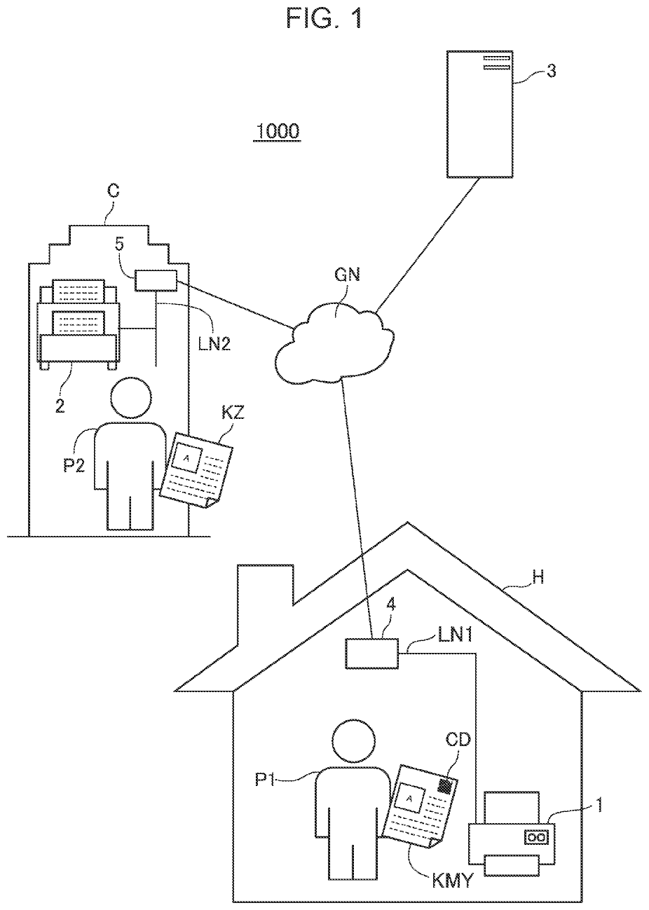

FIG. 1 is a diagram illustrating the configuration of an information processing system 1000.

The information processing system 1000 is a system that performs information processing concerning a question to be given to a learner P1. The information processing system 1000 includes a complex machine 1, a scanner 2, and an information processing server 3. The complex machine 1 corresponds to an example of the reading apparatus and the printer. The scanner 2 corresponds to an example of the processing apparatus. The information processing server 3 corresponds to an example of the information processing apparatus.

The complex machine 1 is referred to as an MFP (multi function peripherals) and is an apparatus configured to perform various kinds of processing, such as printing, scanning, and the like. The complex machine 1 is disposed in a home H of the learner P1 and is used by the learner P1. The complex machine 1 is connected to a local network LN1 disposed in the home H and communicates with a device connected to a global network GN via a communication device 4 coupled to the local network LN1. The global network GN includes the Internet, a telephone network, and the other communication networks. The communication device 4 is an interface device for connecting a device connected to the local network LN1 to the global network GN.

The learner P1 places answered question paper on the complex machine 1 in learning using question paper, and causes the complex machine 1 to read the print surface of the question paper. The question paper may be question paper including an answer field. Hereinafter question paper answered by the learner P1 is referred to as “answered question paper” and is given a sign “KMY”. On the print surface of the answered question paper KMY, a question and a code CD including a learner ID 3111 identifying the learner P1 are printed. The code CD is a code, such as a barcode, a QR code, or the like. A QR code is a registered trademark. After the complex machine 1 reads the answered question paper KMY, the complex machine 1 transmits read data to the information processing server 3. Hereinafter the read data is referred to as “answered question paper read data” and is given a sign “YD1”. The answered question paper read data YD1 corresponds to an example of the read data.

The scanner 2 is an apparatus that reads a character and an image from a reading target. The scanner 2 may be a sheet feed scanner or a flatbed scanner. The scanner 2 is used by a publisher C that provides teaching materials KZ including a question. In the present embodiment, the teaching materials KZ provided by the publisher C are made of a paper medium. The scanner 2 is disposed, for example, in an office of the publisher C. The scanner 2 is connected to a local network LN2 disposed in the office and communicates with a device connected to the global network GN via a communication device 5 coupled to the local network LN2. The publisher C corresponds to an example of the teaching material provider.

The publisher C records the teaching materials KZ in the information processing server 3 by using the scanner 2. Here, recording the teaching materials KZ means storing the teaching materials KZ made of a paper medium in the information processing server 3 as digital content. The employee P2 places the teaching materials KZ to be recorded on the scanner 2 for recording the teaching materials KZ, and causes the scanner 2 to read the print surface of the teaching materials KZ. After the scanner 2 reads the teaching materials KZ, the scanner 2 transmits read data to the information processing server 3. Hereinafter the read data is referred to as “teaching material read data” and is given a sign “YD2”. The teaching material read data YD2 corresponds to an example of the teaching material data.

The information processing server 3 is a server apparatus that performs various kinds of information processing related to a question to be given to the learner P1. The information processing server 3 is connected to the global network GN and communicates with the complex machine 1 and the scanner 2. In this regard, in each diagram, the information processing server 3 is expressed by one block. However, this does not necessarily mean that the information processing server 3 is a single server apparatus. For example, the information processing server 3 may include a plurality of server apparatuses having different processing contents or a plurality of server apparatuses storing different databases.

In this regard, in the present embodiment, the number of complex machines 1 in the information processing system 1000 is not limited to one and may be plural. When a plurality of complex machines 1 are included, each of the plurality of complex machines 1 may be disposed in the home H of different learners P1 or may be disposed in the home H of the same learner P1. Also, regarding the scanner 2 in the information processing system 1000, the number of scanners 2 is not limited to one and may be plural in the same manner as the complex machine 1. When a plurality of scanners 2 are included, each of the plurality of scanners 2 may be used at a different publisher C or may be used at the same publisher C.

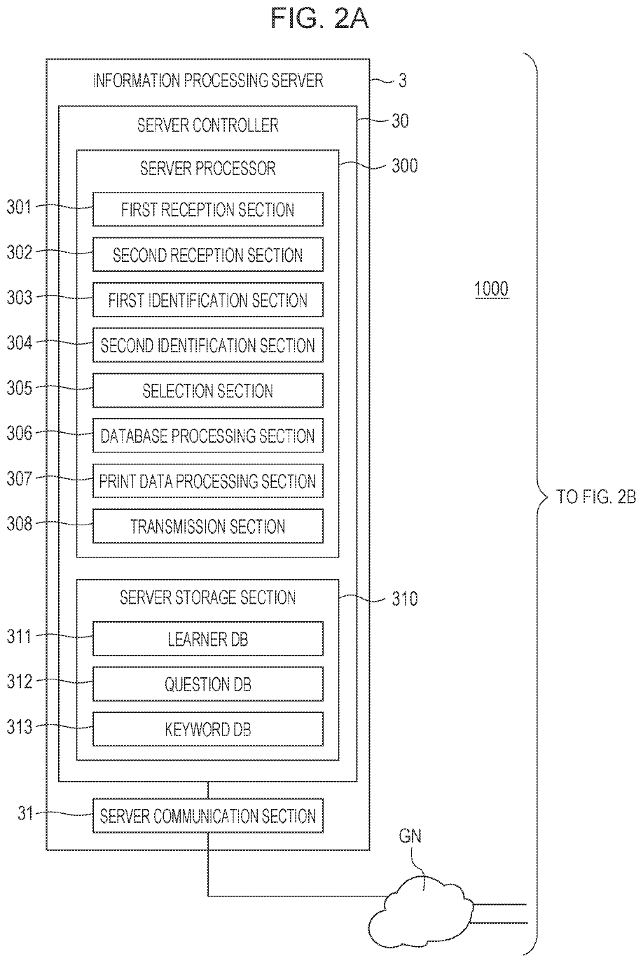

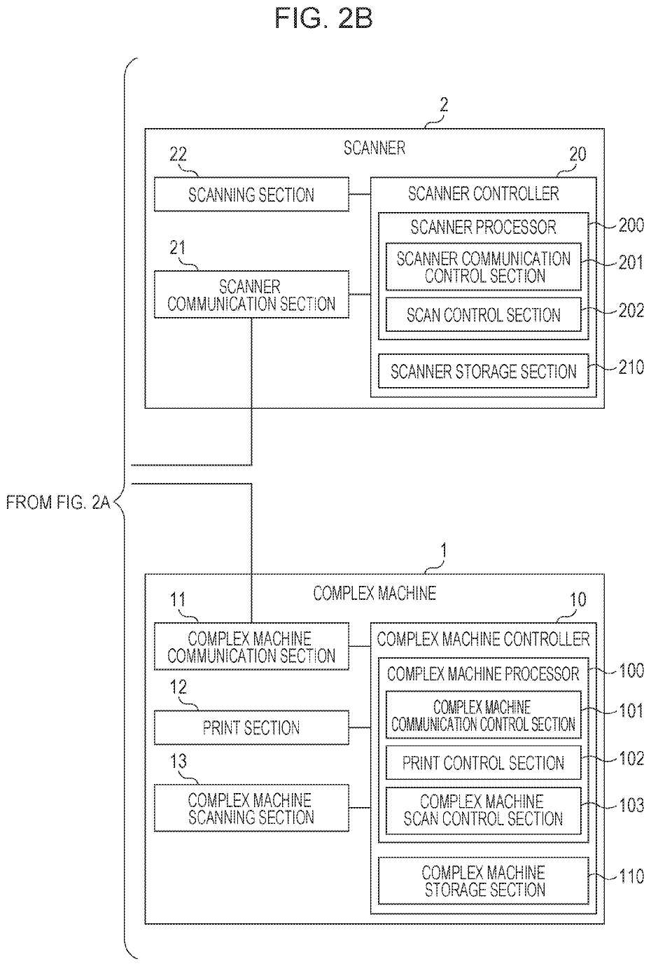

FIGS. 2A and 2B are diagrams illustrating the configuration of each apparatus in the information processing system 1000.

First, a description will be given of the complex machine 1. The complex machine 1 includes a complex machine controller 10, a complex machine communication section 11, a print section 12, and a complex machine scanning section 13.

The complex machine controller 10 includes a complex machine processor 100, which is a processor that executes a program, such as a CPU (central processing unit), an MPU (micro-processing unit), or the like, and a complex machine storage section 110. The complex machine controller 10 controls each section of the complex machine 1 by causing the complex machine processor 100 to read a control program stored in the complex machine storage section 110. The complex machine processor 100 functions as the complex machine communication control section 101, the print control section 102, and the complex machine scan control section 103 by executing the control program stored in the complex machine storage section 110.

The complex machine storage section 110 includes a memory that stores a program to be executed by the complex machine processor 100 and data to be processed by the complex machine processor 100. The complex machine storage section 110 stores a control program to be executed by the complex machine processor 100, and various other kinds of data. The complex machine storage section 110 has a nonvolatile storage area. Also, the complex machine storage section 110 may store a volatile storage area and form a work area for the complex machine processor 100.

The complex machine communication section 11 is a communication interface including a wireless circuit, an antenna, and the like, and communicates with the information processing server 3 in accordance with a predetermined communication standard. The communication standard for the complex machine communication section 11 may be a wireless communication standard or a wired communication standard.

The print section 12 includes components concerning printing, such as an ink jet head that discharges ink onto a print medium to form a dot, a carriage that operates the ink jet head in the scanning direction, a carriage drive motor that drives the carriage, a transport unit that transports the print medium, an ink supply unit that supplies ink to the ink jet head, and the like. The print section 12 discharges ink from a nozzle of the ink jet head to form a dot on the print surface of the print medium under the control of the complex machine controller 10 to perform printing on the print medium.

The complex machine scanning section 13 includes components concerning reading by a scanner that reads a character and an image recorded on a document, and the like. The complex machine scanning section 13 reads, for example, the recorded character and image by radiating light emitted from a light source and outputs the image data obtained by reading to the complex machine controller 10. The complex machine controller 10 performs data processing, such as RGB conversion and compression processing, and the like on the image data input from the complex machine scanning section 13 to generate data in a predetermined format.

The complex machine controller 10 functions as the complex machine communication control section 101, the print control section 102, and the complex machine scan control section 103.

The complex machine communication control section 101 communicates with the information processing server 3 via the complex machine communication section 11.

The print control section 102 controls the print section 12 to perform printing on a print medium based on print data.

The complex machine scan control section 103 controls the complex machine scanning section 13 to read a character or an image from a read target and generates read data.

Next, a description will be given of the scanner 2. The scanner 2 includes a scanner controller 20, a scanner communication section 21, and a scanning section 22.

The scanner controller 20 includes a scanner processor 200, which is a processor that executes a program, such as a CPU, an MPU, and the like, and a scanner storage section 210. The scanner controller 20 controls each section of the scanner 2 by causing the scanner processor 200 to read a control program stored in the scanner storage section 210 and execute the control program. The scanner processor 200 executes the control program stored in the scanner storage section 210 so as to function as a scanner communication control section 201 and a scan control section 202.

The scanner storage section 210 includes a memory that stores a program to be executed by the scanner processor 200 and data to be processed by the scanner processor 200. The scanner storage section 210 stores a control program to be executed by the scanner processor 200 and various other kinds of data. The scanner storage section 210 has a nonvolatile storage area. Also, the scanner storage section 210 may include a volatile storage area and form a work area for the scanner processor 200.

The scanner communication section 21 is a communication interface including a wireless circuit, an antenna, and the like, and communicates with the information processing server 3 in accordance with a predetermined communication standard. The communication standard for the scanner communication section 21 may be a wireless communication standard or a wired communication standard.

The scanning section 22 includes components concerning reading by a scanner that reads a character and an image recorded on a document, and the like. The scanning section 22 reads, for example, a recorded character and image by radiating light emitted from a light source, and outputs the image data obtained by reading to the scanner controller 20. The scanner controller 20 performs data processing, such as RGB conversion and compression processing, and the like on the image data input from the scanning section 22, and generates data in a predetermined format as read data.

The scanner controller 20 functions as the scanner communication control section 201 and the scan control section 202.

The scanner communication control section 201 communicates with the information processing server 3 via the scanner communication section 21.

The scan control section 202 controls the scanning section 22 to read a character and an image from a read target, and generates read data.

Next, a description will be given of the information processing server 3. The information processing server 3 includes a server controller 30 and a server communication section 31.

The server controller 30 includes a server processor 300, which is a processor that executes a program, such as a CPU, an MPU, or the like, and a server storage section 310. The server controller 30 controls each section of the information processing server 3 by causing the server processor 300 to read a control program stored in the server storage section 310 and execute the control program. The server processor 300 functions as a first reception section 301, a second reception section 302, a first identification section 303, a second identification section 304, a selection section 305, a database processing section 306, a print data generation section 307, and a transmission section 308 by causing the server processor 300 to read a control program stored in the server storage section 310 and execute the control program stored in the server storage section 310. The server storage section 310 corresponds to an example of the storage section. The database processing section 306 corresponds to an example of the storage control section.

The server storage section 310 includes a memory that stores a program to be executed by the server processor 300 and data to be processed by the server processor 300. The server storage section 310 stores a control program to be executed by the server processor 300, a learner DB 311, a question DB 312, a keyword DB 313, and various other kinds of data. The server storage section 310 has a nonvolatile storage area. Also, the server storage section 310 may have a volatile storage area and form a work area for the server processor 300.

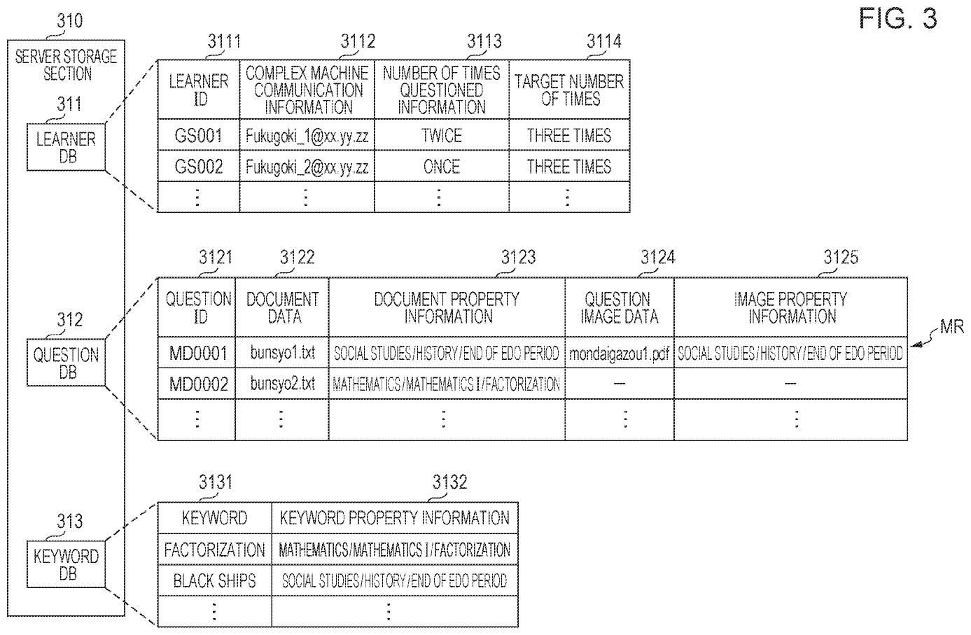

FIG. 3 is a diagram illustrating an example of each database stored in the server storage section 310.

The learner DB 311 is a database that stores information related to the learner P1. Each record stored in the learner DB 311 has a learner ID 3111, complex machine communication information 3112, number of times questioned information 3113, and target number of times information 3114.

The learner ID 3111 is identification information for identifying a learner P1.

The complex machine communication information 3112 is information for communicating with the complex machine 1. When an individual email address is given, for example, to a complex machine 1, the complex machine communication information 3112 is the information indicating the email address.

The number of times questioned information 3113 indicates the number of times a question, which is related to a question in the answered question paper KMY, was given to a learner P1 indicated by a learner ID 3111 associated by the same record. A question selected by a selection section 305 described later is given to the learner P1, and thus the number of times a question was given indicated by the number of times questioned information 3113 indicates the number of times the selection section 305 selected a question. In the present embodiment, a related question indicates a question having the same property. In the present embodiment, the property of a question is exemplified by a combination of a subject area name, a subject name, and a teaching unit.

The target number of times information 3114 indicates a target number of times a question related to a question in the answered question paper KMY is given to the learner P1. The target number of times indicated by the target number of times information may differ depending on the property of a question or depending on the learner P1.

The question DB 312 is a database storing the information related to a question. Each record stored in the question DB 312 has a question ID 3121, document data 3122, document property information 3123, question image data 3124, and image property information 3125. Hereinafter each record stored in the question DB 312 is referred to a “question management record” and is given a sign “MR”. The question management record MR corresponds to an example of the association information.

The question ID 3121 is identification information for identifying a question in the teaching materials KZ.

The document data 3122 is document data included in a question indicated by the question ID 3121 associated by the same question management record MR. In the present embodiment, a case where the document data 3122 is text data is exemplified. However, the data format of the document data 3122 is not limited to a text format.

The document property information 3123 is information indicating the property identified from the document indicated from the document data 3122 associated by the same question management record MR as a property of the question indicated by the question ID 3121 associated by the same question management record MR.

The question image data 3124 is image data indicating an image included in the question ID 3121 associated by the same question management record MR. In the present embodiment, PDF (Portable document Format) is given as an example data format of the question image data 3124. However, the data format of the question image data 3124 is not limited to a PDF format and may be a JPEG format, etc., or the like. Hereinafter an image included in a question is referred to as a “question image” as necessary and is given a sign “MG”.

The image property information 3125 is information indicating the property identified from the question image MG indicated by the question image data 3124 associated by the same question management record MR as a property of the question indicated by the question ID 3121 associated by the same question management record MR.

Hereinafter when the document data 3122 and the question image data 3124 are not distinguished, they are referred to as “question data”. Also, hereinafter when the document property information 3123 and the image property information 3125 are not distinguished, they are referred to as “property information”.

The keyword DB 313 is a database storing information related to the keyword 3131 to be used for a keyword search by the first identification section 303 and the second identification section 304. Each record stored in the keyword DB 313 has a keyword 3131 and keyword property information 3132. The corresponding relationship between a keyword 3131 and keyword property information 3132 in each record is suitably set in advance.

The keyword 3131 is a keyword to be used for a keyword search.

The keyword property information 3132 is information indicating the property of a question including a document including a keyword 3131 associated by the same record.

Referring back to FIGS. 2A and 2B, the server communication section 31 is a communication interface including a component, such as a wireless circuit, an antenna, and the like, and communicates with a device connected to the global network GN in accordance with a predetermined communication standard.

As described above, the server controller 30 functions as the first reception section 301, the second reception section 302, the first identification section 303, the second identification section 304, the selection section 305, the database processing section 306, the print data generation section 307, and the transmission section 308.

The first reception section 301 receives the answered question paper read data YD1 from the complex machine 1 via the server communication section 31.

The second reception section 302 receives teaching material read data YD2 from the scanner 2 via the server communication section 31.

The first identification section 303 identifies a property of a question included in the answered question paper KMY based on the answered question paper read data YD1 received by the first reception section 301. That is to say, the first identification section 303 identifies a property of the question answered by the learner P1 based on the answered question paper read data YD1 received by the first reception section 301.

The second identification section 304 identifies a property of a question included in the teaching materials KZ to be stored based on the teaching material read data YD2 received by the second reception section 302.

The selection section 305 selects a question related to a question included in the answered question paper KMY as a question to be given to the learner P1 based on the answered question paper read data YD1 received by the first reception section 301.

The database processing section 306 generates a record, stores the record, and updates the information on a record for each database stored in the server storage section 310.

The print data generation section 307 generates print data for printing the question selected by the selection section 305. The print data generated by the print data generation section 307 is data to be processed by the complex machine 1 at the time of printing, and includes various control commands conforming to a command system of the complex machine 1.

The transmission section 308 transmits the print data generated by the print data generation section 307 to the complex machine 1 via the server communication section 31.

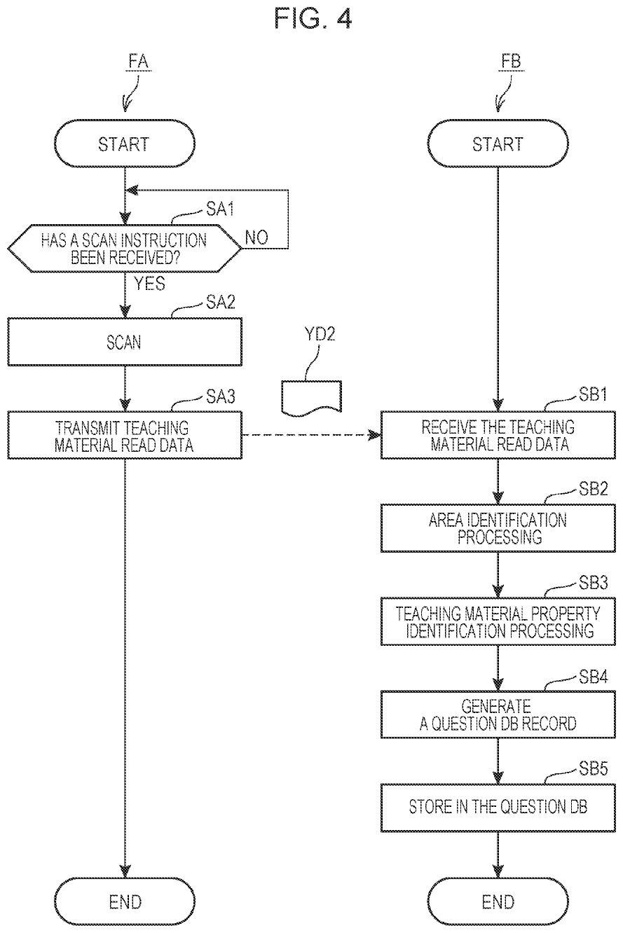

Next, a description will be given of the operation of the information processing system 1000. First, a description will be given of the operation in which the publisher C stores the teaching materials KZ in the information processing server 3. FIG. 4 is a flowchart illustrating the operation of the information processing system 1000. In FIG. 4, a flowchart FA illustrates the operation of the scanner 2, and a flowchart FB illustrates the operation of the information processing server 3.

In this regard, at a point in time when the flowchart FA in FIG. 4 is started, it is assumed that the teaching materials KZ is suitably set by the employee P2 on the scanner 2.

The scan control section 202 of the scanner 2 determines whether or not a scan instruction has been received (step SA1).

When the scan control section 202 determines that a scan instruction has been received (step SA1: YES), the scan control section 202 scans the print surface of the teaching materials KZ by using the scanning section 22 (step SA2).

Next, the scanner communication control section 201 transmits the teaching material read data YD2 obtained by the scanning in step SA2 to the information processing server 3 (step SA3).

As illustrated by the flowchart FB, the second reception section 302 of the information processing server 3 receives the teaching material read data YD2 from the scanner 2 (step SB1).

Next, the second identification section 304 of the information processing server 3 performs area identification processing for identifying a document area BA and a question image area MGA on the image indicated by the teaching material read data YD2 by using a predetermined mechanism, such as an image analysis or the like (step SB3).

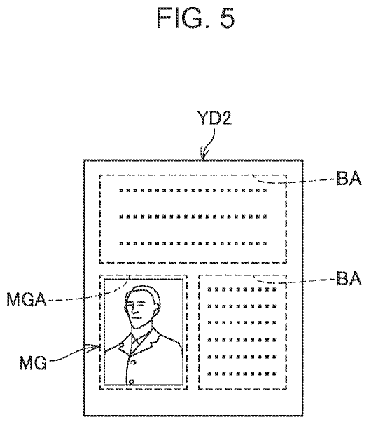

FIG. 5 is a diagram illustrating an example of the teaching material read data YD2. The image illustrated by the teaching material read data YD2 in FIG. 5 indicates a case of including a document and a question image MG. In FIG. 5, “⋅” denotes a character.

The document area BA is an area including a document and not including a question image MG. In the case of FIG. 5, the second identification section 304 identifies two document areas BA.

The question image area MGA is an area including the question image MG and not including a document. In this regard, a character included in the question image MG is regarded as a part of the question image MG. In the case of FIG. 5, the second identification section 304 identifies one question image area MGA.

The second identification section 304 performs teaching material property identification processing for identifying a property of a question included in the teaching materials KZ to be stored based on the processing result of the area identification processing (step SB4).

A detailed description will be given of the teaching material property identification processing in step SB4. In the description of the teaching material property identification processing, a description will be given separately between the case where only a document area BA is identified in the area identification processing and the case where both a document area BA and a question image area MGA are identified in the area identification processing. Hereinafter the former case is referred to as a first case, and the latter is referred to as a second case.

First Case

In the first case, the second identification section 304 performs character recognition, for example, OCR (optical character recognition) on the teaching material read data YD2 and obtains document data 3122 produced by converting the teaching material read data YD2 into a text format.

Next, the second identification section 304 performs keyword search on the obtained document data 3122. In the keyword search, the second identification section 304 searches the obtained document data 3122 for a keyword 3131 stored in the keyword DB 313.

Next, the second identification section 304 identifies a property indicated by the keyword property information 3132 associated with a keyword 3131 hit by the keyword search as a property of the question included in the teaching materials KZ to be stored.

Second Case

In the second case, the second identification section 304 performs character recognition, for example, OCR on the teaching material read data YD2 corresponding to the document area BA and obtains document data 3122 produced by converting the teaching material read data YD2 into a text format.

Next, the second identification section 304 performs keyword search on the obtained document data 3122. In the keyword search, the second identification section 304 searches the obtained document data 3122 for a keyword 3131 stored in the keyword DB 313.

Next, the second identification section 304 identifies question image data 3124 indicating a question image MG having the highest matching rate with the question image MG included in the identified question image area MGA from the question DB 312.

Next, the second identification section 304 identifies a property indicated by the image property information 3125 associated with the question image data 3124 identified from the question DB 312 as a property of the question included in the teaching materials KZ to be stored.

Referring back to the flowchart illustrated in FIG. 4, the database processing section 306 generates a question management record MR based on an identification result of the teaching material property identification processing (step SB5).

When the teaching material property identification processing in the first case is performed in step SB4, the question management record MR generated in step SB5 has the document data 3122 obtained by the first identification section 303. Also, in this case, the question management record MR generated in step SB5 has document property information 3123 indicating the same property as the property indicated by the keyword property information 3132 associated with the keyword 3131 hit in the search.

When the teaching material property identification processing in the second case is performed in step SB4, the question management record MR generated in step SB5 has the document data 3122 obtained by the first identification section 303. Also, the question management record MR generated in step SB5 in this case has document property information 3123 indicating the same property as the property indicated by the keyword property information 3132 associated with the keyword 3131 hit by the search. Also, the question management record MR generated in step SB5 in this case has the question image data 3124 indicating a question image MG included in the question image area MGA. Also, the question management record MR generated in step SB5 in this case has image property information 3125 associated with the question image data 3124 identified from the question DB 312.

After the database processing section 306 generates a question management record MR, the database processing section 306 stores the generated question management record MR in the question DB 312 (step SB6). Thereby, storing the teaching materials KZ is completed.

Next, a description will be given of the operation of the information processing system 1000 when answered question paper KMY is scanned by the complex machine 1.

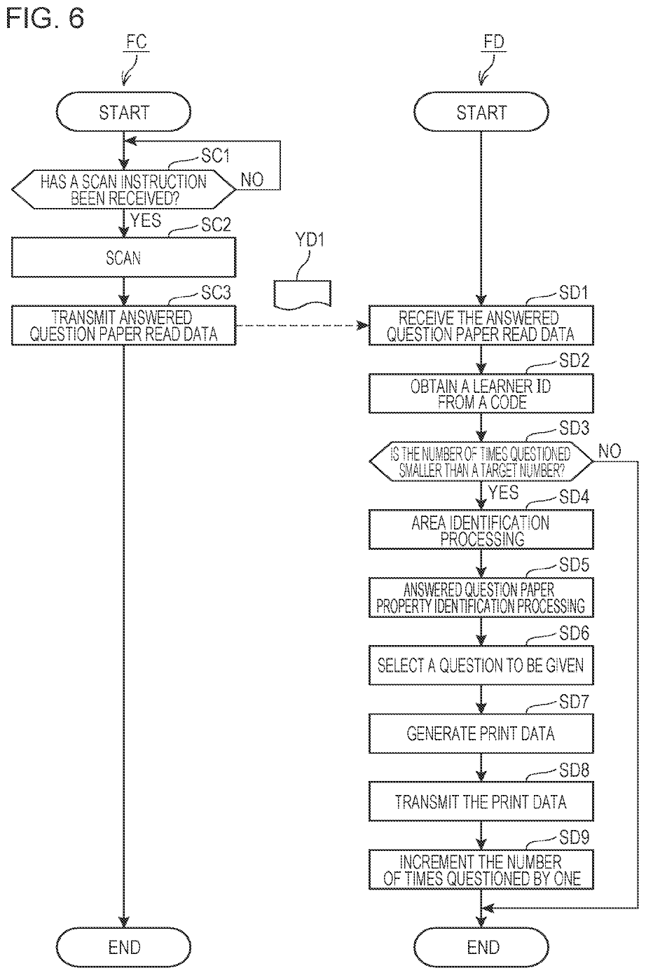

FIG. 6 is a flowchart illustrating the operation of the information processing system 1000. In FIG. 6, a flowchart FC denotes the operation of the complex machine 1, and a flowchart FD denotes the operation of the information processing server 3.

It is assumed that at a point in time when the flowchart FD illustrated in FIG. 6 is started, the learner P1 has set answered question paper KMY in the complex machine 1.

The complex machine scan control section 103 of the complex machine 1 determines whether or not a scan instruction has been received (step SC1).

When the complex machine scan control section 103 determines that a scan instruction has been received (step SC1: YES), the complex machine scanning section 13 scans the print surface of the answered question paper KMY that has been set (step SC2).

The complex machine communication control section 101 transmits the answered question paper read data YD1 obtained by the scan in step SC2 to the information processing server 3 (step SC3).

As illustrated in the flowchart FD, the first reception section 301 of the information processing server 3 receives answered question paper read data YD1 from the complex machine 1 (step SD1).

Next, the selection section 305 obtains a learner ID 3111 from a code CD included in the image indicated by the received answered question paper read data YD1 (step SD2).

Next, the selection section 305 refers to the learner DB 311, and determines whether or not the number of times question asked indicated by the number of times questioned information 3113 associated with the obtained learner ID 3111 is less than the target number of times indicated by the target number of times information 3114 associated with the obtained learner ID 3111 (step SD3).

When the selection section 305 determines that the number of times question asked is not less than the target number of times, that is to say, when the number of times question asked equal to the target number of times (step SD3: NO), this processing ends.

On the other hand, when the selection section 305 determines that the number of times question asked is less than the target number of times (step SD3: YES), the first identification section 303 performs area identification processing for identifying a document area BA and a question image area MGA on the image indicated by the answered question paper read data YD1 by using a predetermined mechanism, for example, an image analysis or the like (step SD4).

The first identification section 303 performs answered question paper property identification processing for identifying a property of the question included in the answered question paper KMY based on the processing result of the area identification processing in step SD4 (step SD5).

A detailed description will be given of the answered question paper property identification processing in step SD5. In the description of the answered question paper property identification processing, a description will be given separately between the first case and the second case.

First Case

In the first case, the first identification section 303 performs character recognition, such as OCR or the like, on the answered question paper read data YD1 and obtains document data 3122 produced by converting the answered question paper read data YD1 into a text format.

Next, the first identification section 303 performs keyword search on the obtained document data 3122. In the keyword search, the first identification section 303 searches the obtained document data 3122 for a keyword 3131 stored in the keyword DB 313.

Next, the first identification section 303 identifies a property indicated by the keyword property information 3132 associated with a keyword 3131 hit by the keyword search as a property of the question included in the answered question paper KMY.

Second Case

In the second case, the first identification section 303 performs character recognition, for example, OCR on the answered question paper read data YD1 corresponding to the document area BA and obtains document data 3122 produced by converting the answered question paper read data YD1 into a text format.

Next, the first identification section 303 performs keyword search on the obtained document data 3122. In the keyword search, the first identification section 303 searches the obtained document data 3122 for a keyword 3131 stored in the keyword DB 313.

Next, the first identification section 303 identifies question image data 3124 indicating a question image MG having the highest matching rate with the question image MG included in the identified question image area MGA from the question DB 312.

Next, the first identification section 303 identifies a property indicated by the image property information 3125 associated with the question image data 3124 identified from the question DB 312 as a property of the question included in the answered question paper KMY.

Referring back to the description of the flowchart in FIG. 6, the selection section 305 selects a question to be given to the learner P1 having the learner ID 3111 obtained in step SD2 from the question indicated by the question data stored in the question DB 312 based on the property identified in the answered question paper property identification processing (step SD6). In step SD6, the selection section 305 selects question data of the question to be given to the learner P1 from the question data stored in the question DB 312.

A detailed description will be given of step SD6. When the first identification section 303 performs the processing in the first case in step SD5, the selection section 305 selects question data associated with the document property information 3123 indicating the same property as the identified property from the question DB 312. In this regard, when the document property information 3123 is associated with the document data 3122 and the question image data 3124, the selection section 305 selects a combination of the two pieces of data as question data of the question to be given to the learner Pl. Also, when the document property information 3123 is associated with only document data 3122, the selection section 305 selects the document data 3122 as question data of the question to be given to the learner P1.

When the first identification section 303 performs the processing in the second case in step SD5 and identifies a property of a question included in the answered question paper KMY from each of an image and a document included in the question included in the answered question paper KMY, the selection section 305 selects question data in the following manner. That is to say, the selection section 305 selects question data based on the property identified from the document data 3122 in preference to the property identified from the question image data 3124. The selection section 305 selects question data associated with the document property information 3123 having the same property as the property identified from the document data 3122 from the question DB 312. In this regard, when it is not possible for the selection section 305 to select question data from the question DB 312 based on the property identified from the document data 3122, the selection section 305 selects question data from the question DB 312 based on the property identified from the question image data 3124.

The print data generation section 307 generates print data for printing a question indicated by the question data selected by the selection section 305 from the question DB 312 and a code CD indicating the learner ID 3111 obtained in step SD2 (step SD7).

The transmission section 308 transmits the print data generated by the print data generation section 307 based on the complex machine communication information 3112 associated with the learner ID 3111 obtained in step SD2 to the complex machine 1 (step SD8).

When the complex machine communication control section 101 receives the print data, the print control section 102 of the complex machine 1 performs printing based on the received print data. Thereby, the learner P1 is provided with question paper on which a question related to the question in the answered question paper KMY is printed.

After the transmission section 308 transmits print data, the database processing section 306 increments by one the number of times questioned indicated by the number of times questioned information 3113 associated with the learner ID 3111 obtained in step SD2 (step SD9).

As described above, the information processing server 3 includes the server storage section 310 that stores a question management record MR in which property information indicating a property of a question is associated with question data indicating a question, the first reception section 301 that receives answered question paper read data YD1 from the complex machine 1, the first identification section 303 that identifies a property of a question included in the answered question paper KMY based on the answered question paper read data YD1 received by the first reception section 301, and the selection section 305 that selects a question to be given to the learner P1 from a question indicated by the question data stored in the server storage section 310 based on the property identified by the first identification section 303.

Also, the control method of the information processing server 3 includes storing question management record MR in which property information indicating a property of a question and question data indicating a question are associated, receiving answered question paper read data YD1 from the complex machine 1, identifying a property of a question included in the answered question paper KMY based on the received answered question paper read data YD1, and selecting a question to be given to the learner P1 from the question indicated by the stored question data based on the identified property.

With the information processing server 3 and the control method of the information processing server 3, a question to be given to the learner P1 is selected based on a property of a question included in the answered question paper KMY, and thus it is possible to select a question to be given to the learner P1 in consideration of the question in the question paper answered by the learner P1.

The selection section 305 selects a question indicated by the question data associated with the property information indicating the property identical to the property identified by first identification section 303 as a question to be given to the learner P1.

With this configuration, a question having a property identical to the property of the question included in the answered question paper KMY is selected as a question to be given to the learner P1, and thus it is possible to select a question related to a question in the question paper answered by the learner P1 as a question to be given to the learner P1.

When a question included in the answered question paper KMY includes an image and a document, the first identification section 303 identifies a property of a question included in the answered question paper KMY from each of the image and the document included in the answered question paper KMY. When a question included in the answered question paper KMY includes an image and a document, the selection section 305 selects a question to be given to the learner P1 based on the property identified from the document included in the answered question paper KMY in preference to the property identified from the image included in the answered question paper KMY.

When a question includes an image and a document, the question image MG is possibly accompanying information for supplementing the contents of the document. Thus, it is highly probable that a property identified from the document included in the question is more correct than a property identified from the question image MG. Accordingly, by selecting a property identified from the document in preference as a question to be given to the learner P1, it is possible to select a question having a higher degree of association with a question in the question paper answered by the learner P1 as a question to be given to the learner P1.

The information processing server 3 includes the transmission section 308 that transmits print data for printing the question selected by the selection section 305 to the complex machine 1 used by the learner P1.

With this configuration, it is possible to provide the learner P1 with the question selected in consideration of the question in the question paper answered by the learner P1.

The answered question paper KMY is the question paper generated by the complex machine 1 based on the print data. The selection section 305 makes a selection until the number of times selected based on the property identified by the first identification section 303, that is to say, the number of times questioned reaches the target number of times determined in advance based on the property identified by the first identification section 303.

With this configuration, it is possible to repeatedly provide the learner P1 with a question selected in consideration of the question in the question paper answered by the learner P1. In particular, since the selection section 305 selects a question having a property identical to the property of the question included in the answered question paper KMY as a question to be given to the learner P1, it is possible to repeatedly provide the learner P1 with a question related to a question in the question paper answered by the learner P1.

The information processing server 3 includes the second reception section 302 that receives teaching material read data YD2, which is read data of the teaching materials KZ including a question from the scanner 2 used by the publisher C, second identification section 304 that identifies a property of a question included in the teaching materials KZ based on the teaching material read data YD2 received by the second reception section 302, and the database processing section 306 that stores a question management record MR in which property information indicating a property identified by the second identification section 304 is associated with the question data indicating a question included in the teaching materials KZ in the server storage section 310.

With this configuration, it becomes possible to include a question included in the teaching materials KZ provided by the publisher C in the question management record MR as data. Accordingly, it is possible to select a question to be given to the learner P1 from a question included in the teaching materials KZ provided by the publisher C in consideration of the question included in the question paper answered by the learner P1.

The second identification section 304 obtains document data 3122 indicating a document included in the teaching materials KZ from the teaching material read data YD2, and identifies a property of a question included in the teaching materials KZ based on the obtained document data 3122. The database processing section 306 stores a question management record MR in which document property information 3123 indicating the property identified by the second identification section 304 based on the document data 3122 is associated with the document data 3122 obtained by the second identification section 304 in the server storage section 310.

With this configuration, it is possible to include a document included in the question in the teaching materials KZ provided by the publisher C in a question management record MR as data. Accordingly, it is possible to select a question to be given to the learner P1 from a question included in the teaching materials KZ provided by the publisher C in consideration of the question in the question paper answered by the learner P1.

The second identification section 304 obtains question image data 3124 indicating an image included in the question included in the teaching materials KZ from the teaching material read data YD2, and identifies a property of a question included in the teaching materials KZ based on the obtained question image data 3124. The database processing section 306 stores a question management record MR in which the image property information 3125 indicating the property identified by the second identification section 304 based on the question image data 3124 is associated with the question image data 3124 obtained by the second identification section 304 in the server storage section 310.

With this configuration, it becomes possible to include an image and a document included in the question in the teaching materials KZ provided by the publisher C as data in a question management record MR. Accordingly, it is possible to select a question to be given to the learner P1 from a question, which is included in the teaching materials provided by the publisher C and is formed by an image and a document, in consideration of the question of the question paper answered by the learner P1.

The embodiment described above indicates only one aspect of the present disclosure, and variations and application are possible in any way within the scope of the present disclosure.

In the embodiment described above, a serial ink jet method is exemplified as a printing method of the complex machine 1. However, the printing method of the complex machine 1 may be a line ink jet method. Also, the printing method of the complex machine 1 is not limited to an ink jet method, and may be another printing method, such as an electrophotographic method or the like. Also, the complex machine 1 may be an apparatus having various further functions such as a facsimile function and the like.

In the embodiment described above, the complex machine 1 is exemplified as the reading apparatus and the printer. However, the reading apparatus and the printer may be separate apparatuses. In this case, the reading apparatus may be constituted, for example, by a scanner, and the printer may be constituted, for example, by a printer.

Also, in the embodiment described above, the scanner 2 is exemplified as the processing apparatus. However, the processing apparatus is not limited to the scanner 2 and may be an apparatus without a scan function such as a PC (personal computer) or the like. When the processing apparatus is constituted by a PC, the PC stores teaching material data indicating teaching materials KZ, for example, in a PDF format. The PC transmits the stored teaching material data to the information processing server 3 in accordance with user operation.

Also, in the embodiment described above, when the scanner 2 performs scanning, teaching material read data YD2 is automatically transmitted to the information processing server 3. However, the teaching material read data YD2 may be temporarily stored in the scanner 2 or an external device coupled to the scanner 2, and may be transmitted to the information processing server 3 in accordance with user instruction.

Also, in the embodiment described above, a combination of a subject area name, a subject name, and a teaching unit is exemplified as a property of a question. However, the property of the question is not limited to this, and may include the other properties, for example, a target grade, a subject, and the like in addition to or instead of any one of a subject area name, a subject name, and a teaching unit.

Also, in the embodiment described above, the question paper and the answered question paper KMY that are generated by the complex machine 1 used by the learner P1 include a code CD. However, the question paper and the answered question paper KMY may not include a code CD. In this case, the learner P1 inputs the learner ID 3111 in the complex machine 1, and the complex machine 1 transmits the answered question paper read data YD1 and the input learner ID 3111 to the information processing server 3.

In the embodiment described above, when the first identification section 303 and the second identification section 304 fails in a keyword search from the document data 3122, or instead of the keyword search, AI (artificial intelligence) may be used for the identification. The information processing server 3 performs machine learning processing for learning a property of a question from, for example, document data 3122 for a teacher, and builds a trained model in advance. The trained model is stored in the server storage section 310 in advance. The first identification section 303 and the second identification section 304 identifies a property of the question by referring to the trained model by using the obtained document data 3122 as input data. In this regard, the first identification section 303 and the second identification section 304 may identify the question image data 3124 by using AI in the same manner.

In the embodiment described above, the first identification section 303 and the second identification section 304 refer to the question DB 312 at the time of identifying a property of the question from the question image data 3124. However, the first identification section 303 and the second identification section 304 may refer to a database different from the question DB 312 at the time of identifying a property of the question from the question image data 3124. Each record stored in the database includes property information indicating the property of the question and image data indicating an image.

In the embodiment described above, the publisher C is exemplified as the teaching material provider. However, the teaching material provider is not limited to the publisher C. The teaching material provider may be anyone who provides the teaching materials KZ, and may be a school, a cram school, or the like.

Also, the functions of the complex machine controller 10, the scanner controller 20, and the server controller 30 may be realized by a plurality of processors or semiconductor chips.

Also, each section illustrated in FIGS. 2A and 2B is an example, and a specific implementation form is not limited in particular. That is to say, it is not necessary that each section needs to be implemented in a separately corresponding hardware. Of course, it is possible to realize the function of each section by one processor executing a program. Also, in the embodiment described above, a part of the functions realized by software may be implemented by hardware, or a part of the functions realized by hardware may be implemented by software. In addition, it is possible to change the detailed configuration of each of the other sections of the complex machine 1, the scanner 2, and the information processing server 3 in any way within the spirit and the scope of the present disclosure.

Also, the step units of the operation illustrated in FIG. 4 and FIG. 6 are divided in accordance with the major processing contents to facilitate understanding of the operation of each apparatus in the information processing system 1000. The present disclosure is not limited by the way of dividing a processing unit and the name of a processing unit. The operation may be further divided into many step units in accordance with the processing contents. Also, one step unit may be divided into units so as to include further processing. Also, the order of the steps may be suitably changed.

What is claimed is:

1. An information processing apparatus comprising:
a storage section storing association information associating property information indicating a property of a question and question data indicating a question;
a first reception section configured to receive read data of answered question paper answered by a learner from a reading apparatus;
a first identification section configured to identify a property of a question included in the answered question paper based on the read data received by the first reception section; and
a selection section configured to select a question to be given to the learner from the question indicated by the question data stored in the storage section based on the property identified by the first identification section.

2. The information processing apparatus according to claim 1, wherein
the selection section selects a question indicated by the question data associated with the property information indicating a property identical to the property identified by the first identification section as the question to be given to the learner.

3. The information processing apparatus according to claim 2, wherein
when a question included in the answered question paper includes an image and a document, the first identification section identifies a property of the question included in the answered question paper from each of the image and the document included in the question included in the answered question paper; and
when a question included in the answered question paper includes an image and a document, the selection section selects a question to be given to the learner based on a property identified from the document included in the question included in the answered question paper in preference to a property identified from the image included in the question included in the answered question paper.

4. The information processing apparatus according to claim 1, further comprising:
a transmission section configured to transmit print data for printing a question selected by the selection section to a printer used by the learner.

5. The information processing apparatus according to claim 4, wherein
the answered question paper is question paper generated by the printer based on the print data, and
the selection section makes a selection based on the property identified by the first identification section until a number of times selected based on the property identified by the first identification section reaches a target number of times.

6. The information processing apparatus according to claim 5, wherein
the target number of times is determined in accordance with the property of the question or the learner.

7. The information processing apparatus according to claim 1, further comprising:
a second reception section configured to receive teaching material data indicating teaching materials including a question from a processing apparatus used by a teaching material provider;
a second identification section configured to identify a property of the question included in the teaching materials based on the teaching material data received by the second reception section; and
a storage control section configured to store the association information associating the property information indicating the property identified by the second identification section with the question data indicating a question included in the teaching materials in the storage section.

8. The information processing apparatus according to claim 7, wherein
the second identification section obtains document data indicating a document included in a question included in the teaching materials from the teaching material data, and identifies a property of a question included in the teaching materials based on the obtained document data; and
the storage control section determines document property information indicating the property identified by the second identification section based on the document data to be the property information, determines the document data obtained by the second identification section to be the question data, and stores the association information associating the document property information with the document data in the storage section.

9. The information processing apparatus according to claim 8, wherein
the second identification section obtains question image data indicating an image included in the question included in the teaching materials from the teaching material data, and identifies a property of the question included in the teaching materials based on the obtained question image data, and
the storage control section determines image property information indicating the property identified by the second identification section based on the question image data to be the property information, determines the question image data obtained by the second identification section to be the question data, and stores the association information associating the image property information with the question image data in the storage section.

10. A control method of an information processing apparatus, the control method comprising:
storing association information associating property information indicating a property of a question and question data indicating a question;
receiving read data of answered question paper answered by a learner from a reading apparatus;
identifying a property of a question included in the answered question paper based on the received read data; and
selecting a question to be given to the learner from the question indicated by the stored question data based on the identified property.
